(19) United States
(12) Patent Application Publication
(10) Pub. No.: US 2002/0082853 A1
(43) Pub. Date: Jun. 27, 2002

(54) Photo Delivery System

(76) Inventor: Doug Goodwin, Woodland Hills, CA (US)

Correspondence Address: LAW OFFICES OF CLEMENT CHENG, CLEMENT CHENG, ESQ., DAIMLER CHRYSLER BUILDING, 7700 IRVINE CENTER DRIVE #710, IRVINE, CA, 92618, US

(21) Appl. No.: 09/752,583

(22) Filed: Dec. 21, 2000

(51) Int. Cl. G06F 17/60

(52) U.S. Cl. 705/1

(57) ABSTRACT

The customer is the sender who places an order with a merchant to have gifts delivered to a receiver. The sender can order online, by phone or at a storefront. When placing the order, the sender gives the merchant the sender's email address or postal address. The sender places an order with a delivery address and a delivery person with a digital camera delivers the gifts. When the gift is handed to the receiver, the delivery person captures at least one digital image with the camera. The image can be a video and audio clip from a digital camcorder. The receiver can also attach a short message of thanks to the image. The image can then be sent to the sender.

### BACKGROUND

The proliferation of Internet commerce has allowed consumers to purchase gifts online to be sent to recipients often many hundreds of miles away. Sugimori 6,047,265 shows an online shopping system that allows an individual to select and pay for a gift online. Moen 5,864,604 references customizable multimedia Internet based greeting card features.

When ordering a gift online to be shipped to a loved one, business contact or friend, the sender of the gift often receives little feedback as to the quality of the gift. Unless the sender physically visits the recipient later, there is often little knowledge as to the quality of the goods and the timeliness of delivery.

The sender often has little protection against fraud and does not have the time to follow up and ensure a quality gift delivery. Recipients of gifts may try to be polite and offer positive comments on gifts that are of poor quality or that were damaged during shipment. Thus, the market needs a method to reliably ensure that remotely ordered gifts have quality and are timely received.

Also, Internet ordered gifts are very generic in that hundreds of others may be receiving the exact same gift in any given day. Sending a card with a gift often a touch of personalization. West 6,011,833, discloses a gift sending system that allows a sender to send a gift with a telephone number. The recipient can call the phone number to hear a personalized message. Barber 5,251,251 allows a subscriber to select a prerecorded message from a library. A greeting card is sent to the recipient with directions for listening to the recorded message.

Small 5,513,117 discloses a system wherein a sending party can use a PC to enter gift selection and personalized card. After payment by a credit card, a message is sent to the receiving party with the personalized card. The receiving party is given a telephone number with a pin number to call to find out what the gift is.

### DESCRIPTION OF THE DRAWINGS

Figure One is a diagram of the photo delivery system.

### DETAILED DESCRIPTION

The invention is a photo delivery service system. The object of the invention is to deliver a digital image of a recipient receiving a gift to the sender of the gift.

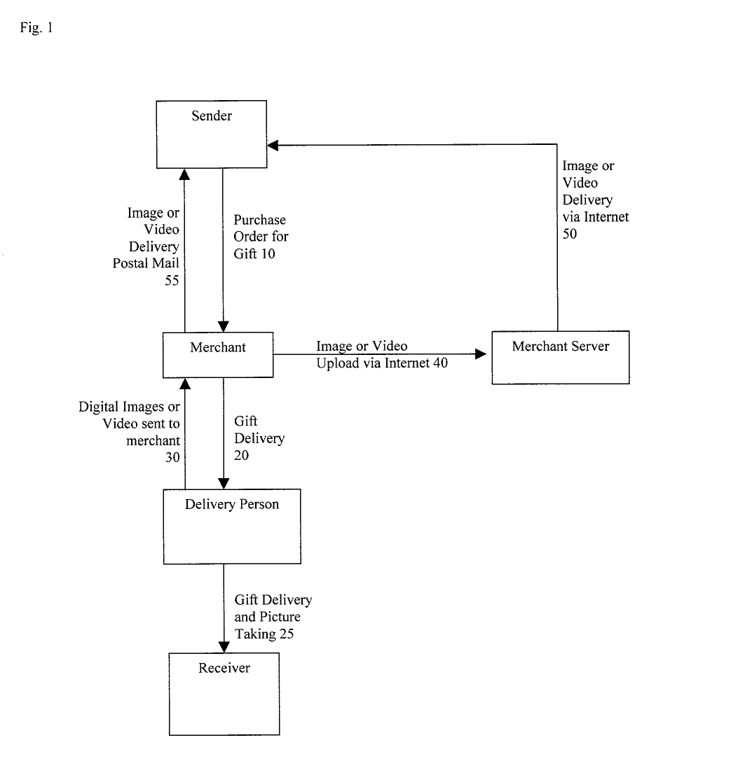

The customer is the sender who places an order with a merchant 10, FIG. 1, to have gifts delivered to a receiver. The sender can order online, by phone or at a storefront. When placing the order, the sender gives the merchant the sender's email address or postal address. The sender places an order with a delivery address and a delivery person with a digital camera delivers the gifts 20. When the gift is handed to the receiver, the delivery person captures at least one digital image with the camera 25. The image can be a video and audio clip from a digital camcorder 30. The receiver can also attach a short message of thanks to the image. The image can then be sent to the sender.

An Internet enabled method can organize images, messages and all contact information about an order. When a customer creates an order, the merchant creates a customer file on the merchant's server. The delivery person uploads the captured images to the customer file 40. The images can then be digitally watermarked or otherwise coded with the date and recipient's name. The merchant's server then emails the picture to the sender or emails a hyperlink pointing to the image 50. The delivery person or merchant can also directly mail a copy of the image to the sender 55.

Many merchants may like to have the photo delivery service without additional overhead. In this case, a photo delivery service company can give the delivery person a digital camera. The photo delivery service company would offer additional compensation to the delivery person for the photo service. Alternatively, the photo delivery service company can perform the deliveries by hiring their own delivery persons. In any case, when the delivery person is done with a route, they simply upload the pictures and text to a merchant server operated by the photo delivery service company. The photo delivery service company then sends an email to the customer.

The server database holding a library of delivered flowers, gifts or other goods, can be referenced for future orders. For example, if a flower customer comes back to a merchant flower store in a few months and asks for the same arrangement they previously ordered, the merchant can use the customer's stored image to reproduce a similar flower arrangement.

1. A method for delivering images comprising the steps of:
a. having a merchant take an order from a sender for delivery of a gift to a recipient,
b. having a delivery person deliver said gift to the recipient,
c. having a delivery person capture an image of the recipient,
d. sending said image of recipient to said merchant;
e. transmitting the image to the sending party.

2. The invention of claim 1, wherein the delivery person captures a digital image of the recipient, wherein said digital image is sent to a merchant who stores it on a merchant server, and wherein claim 1 further comprises the step of delivering the image to the sender from the merchant server.

3. The invention of claim 2 further comprising the steps of capturing a video of the recipient, sending the video to the merchant server, and delivering the video from the merchant server to the sender.

4. The invention of claim 2 further comprising the steps of capturing a message from the recipient, sending the message to the merchant who stores it on a merchant server along with the image, and delivering the image to the sender from the merchant server.

5. A method for delivering images comprising the steps of:
f. having a merchant take an order from a sender for delivery of a gift to a recipient,
g. having a delivery person deliver said gift to the recipient,
h. having a delivery person capture an image of the recipient,
i. transmitting the image to the sending party.
